(19) United States
(12) Patent Application Publication
(10) Pub. No.: US 2007/0011037 A1
(43) Pub. Date: Jan. 11, 2007

(54) Workflow system, workflow management method and program

(75) Inventors: Kouji Demizu, Kawasaki (JP); Yukihiko Furumoto, Kawasaki (JP); Makoto Kobayashi, Kawasaki (JP); Tsukasa Temma, Kawasaki (JP); Masayuki Kidera, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/356,236

(22) Filed: Feb. 17, 2006

(30) Foreign Application Priority Data
Jul. 11, 2005 (JP) 2005-201214

(51) Int. Cl. G06F 9/44

(52) U.S. Cl. 705/7

(57) ABSTRACT

A workflow system for managing a workflow comprising a flow and work, comprising a work management unit for managing the work, a route management unit for managing a route representing a part of the workflow and a flow management unit for managing the flow to maintain a route in the lower hierarchy of said route.

### BACKGROUND OF THE INVENTION

1. Field of the Invention

The present invention relates to a workflow system, which allows to visualize an operation flow, and particularly relates to the workflow system in which a viewer of the workflow can freely change the degree of abstraction of the workflow display, and also a creator can easily divert a part of an existing workflow.

2. Description of the Related Art

In general, a workflow is used as one of the methods for expressing an operation flow.

A viewer referring to a workflow can be either a worker or an operation manager (or a person in a position between the above two). Workers refer to the workflow and carry out (a part of) assigned operations by working in accordance with the workflow. Operation managers manage the progress of the operations by comparing the progress of the actual work with the workflow.

A creator of a workflow defines an operation as a series of work by analyzing details of the operation and dividing the operation into work units, and expresses the operation by a workflow.

When referring to a workflow as a worker, the worker would expect the workflow to describe various kinds of information, which are necessary for carrying out the actual work. However, when referring to such a workflow as an operation manager, it would be difficult to have an overview of the entire operation because a workflow in which all of the detailed works are described is displayed and such a workflow is excessively large in its size.

There are three kinds of methods possible to take to solve this problem.

The first method is to create a workflow, which is neither too approximate not detailed but follows an intermediate course. In this case, both workers and operation managers use the same workflow; however both sides would find the workflow hard to use and it often ends up being unused by both sides.

The second method is to create a detailed workflow for reference for workers and a highly abstract workflow for reference for operation managers. However, in this method, a number of independent workflows, which are (partially) different in the degree of abstraction, exist for one operation. When changing the registered content, all of the related workflows have to be corrected, and thus it is difficult to keep the workflow consistent.

The third method is to define a workflow by hierarchizing the operation. By a viewer switching the hierarchies to refer to, it is possible for workers to view sufficiently detailed work, and for operation managers to see an overview of the whole. For a workflow creator, also, by dividing a part of a workflow into more detailed works, or by defining highly abstract work, the workflow management is facilitated, compared with the second method, which is to define a number of independent workflows.

In Patent Document 1 (Japanese laid-open unexamined patent publication No. 11-316780), one of the technologies using the third method is disclosed.

In Patent Document 1, a system, to which only easy maintenance is required by making a sub business process independent from the upper business process when establishing a hierarchized process, is established.

Patent Document 2 (Japanese laid-open unexamined patent publication No. 2003-203148) also discloses one type of the third method in which a workflow is established by hierarchizing.

In Patent Document 3 (Japanese laid-open unexamined patent publication No. 2002-304428), by making the specification of a workflow etc. into components, a specification exchange device, which performs effective reuse, is realized.

There are such problems in dealing with a workflow as the following:

(1) A work with an obscure distinction often appears in a operation

For example, as shown in FIG. 1 as an example, when data created in a work A is used in concert with a work B, a work T, which converts an output format of the work A into an input format of the work B, may be required.

Such a work T is small in its scale of work, and is a nonessential work for the operation. Therefore either the work A or the work B may perform the work T in accordance with the loading state under practical circumstance. However, because the workflow has to define the work T as being incorporated in either the work A or the work B, the workflow can be inconsistent with the actual conditions.

When the workflow is defined with the work T as a work relating to neither the work A nor the work B, the upper hierarchy of the work T does not exist. Then, the work T is displayed to operation managers referring to the workflow with an abstract upper hierarchy, and an overview of the entire operation can be obscured

(2) The work T is ranked as the deepest level (the level defining the most specific and detailed work) of the hierarchy; however it is possibly situated in the lower hierarchy of either the work A or the work B as shown in FIG. 2. Then, when diverting either the work A or the work B to another workflow, there is a problem that the work T is failed to be diverted.

(3) Because the work T can be situated in the work A and in the work B, in the case of FIG. 2, when a lower hierarchy 1 is selected in the work A, a lower hierarchy 2 must be selected in the work B and when a lower hierarchy 2 is selected in the work A, then a lower hierarchy 1 must be selected in the work B. Therefore, if the works are not selected properly as described above, the workflow would be inconsistent.

When there are two ways of work performances by a1 and by a2 as a lower hierarchy of the work A, two ways of work performances by b1 and by b2 as a lower hierarchy of the work B, and associated work 2a and 2b equivalent to the work T between the work as the lower hierarchy, the work defined as the lower hierarchy can be in six ways(1a-1˜1a-6 and 1b-1˜1b-6) in each of the work A and the work B, and there are 6×6=36 combinations. It is obvious that the number of the combinations reaches an enormous number when the types of the lower hierarchy increase. Then, the workflow must select the proper combination from the enormous number.

As described above, in a workflow comprising a work, which is nonessential to the original operation and belongs to either of the preceding work or the subsequent work, the workflow has to be defined regarding the lowest hierarchy of the preceding or the subsequent work and therefore it is a complicated work for the workflow creators.

A system of Patent Document 1 has the problems described above (2) and (3). It is an object of the present invention to provide a workflow system to solve the above problems.

### SUMMARY OF THE INVENTION

The workflow creation system of the present invention, premised on managing a workflow comprising a flow and work, comprises a work management unit, a route management unit and a flow management unit.

The work management unit manages the work.

The route management unit manages a route representing a part of the workflow.

The flow management unit manages the flow to maintain a route in the hierarchy lower than the above route.

Such a configuration facilitates handling of a work with an obscure distinction because the work can be defined in the lower hierarchy of the flow.

The configuration may further comprise an output unit for display-outputting the workflow and an output management unit for, when a flow designated by a user comprises the route, causing the output unit to display-output the workflow in which the flow designated by a user is replaced by the route.

Such a configuration facilitates to change a part that a user of the workflow intends to display in greater detail into a display of the workflow in lower hierarchy.

The configuration may, also, comprise an output unit for display-outputting the workflow, and an output management unit for, when a flow, comprising a flow or work designated by a user as the route, is present, causing the output unit to display-output the workflow in which the flow and work comprised in the route are replaced by the flow.

This configuration facilitates to change a part that a user of the workflow intends to display its overview into a display of the workflow in higher hierarchy.

It is also possible to configure it so that the existing flow can be easily diverted to the other workflow.

In addition, the scope of the present invention includes not only a workflow system but also a workflow management method and a program.

According to the present invention, a work with an obscure distinction, which can be performed either in the preceding work or the subsequent work, can be defined in the lower hierarchy of the flow, and the work can be defined as a work different from the preceding and the subsequent work.

Because a drastic increase in the number of combinations of the lower hierarchy can be contained in the lower hierarchy of the flow, the number of the combinations can be kept low.

It is also possible to search a flow from the workflow registered in the past and to divert it to a new workflow easily. At that time, it is possible to divert the lower hierarchy along with the flow, and therefore the burden on a workflow creator can be reduced.

Further, whether a flow is connectable or not can be determined when diverting a flow, and thus reliability and percentage completion of a new workflow created by diverting flows from the existing workflow can be improved.

It is also possible to go into details (i.e. display a route in the lower hierarchy) or to abstract (i.e. display a route in the higher hierarchy) of only a part of the workflow, enabling the workflow to express the overview as well as details in a necessary part.

Moreover, in showing details of the workflow, if a plurality of the lower hierarchy routes are present, all the routes are displayed allowing a user to select a route, and thus the workflow provides more flexible use than the existing workflow.

### BRIEF DESCRIPTION OF THE DRAWINGS

FIG. 1 is a diagram describing an example of a work with an obscure distinction;

FIG. 2 is a diagram describing an example that an output-convert work T is defined as the lower hierarchy of the work;

FIG. 3 is a diagram describing combination examples of lower hierarchy work in the existing work A and work B;

FIG. 4 is a block diagram illustrating an overview configuration of the workflow system of the present embodiment;

FIG. 5 is a diagram explaining an overview of the way to manage the workflow performed in the workflow system of the present embodiment;

FIG. 6A is a diagram describing a flow with lower hierarchy and FIG. 6B is a diagram describing a route in the flow;

FIG. 7 is a diagram describing an example of a route with lower hierarchy and its lower hierarchy route expressed in the lower hierarchy;

FIG. 8 is a diagram describing the case that all routes present in a workflow shown as an example are displayed;

FIG. 9 is a diagram describing the case that only the route R0 is displayed;

FIG. 10 is a diagram describing a display switched so as to display the route R1 contained in the route TF1;

FIG. 11 is a diagram describing a display switched so as to display the route R2 and the route R3 contained in the route TF1;

FIG. 12 is a diagram showing an example of configuration of the route management table;

FIG. 13 is a diagram showing an example of configuration of the connection management table;

FIG. 14 is a diagram showing an example of configuration of the work management table;

FIG. 15 is a diagram showing an example of configuration of the flow table;

FIG. 16 is a diagram showing an example of configuration of the data table;

FIG. 17 is a flowchart showing an operation processing of the workflow system when a display of a workflow is switched to that of a more detailed workflow;

FIG. 18A, FIG. 18B and FIG. 18C are diagrams describing an example of screen handling processing when switching a display into a more detailed workflow;

FIG. 19 is a flowchart showing processing when a workflow is switched to overview workflow;

FIG. 20A and FIG. 20B are diagrams describing an example of screen handling processing when switching a display into an overview workflow;

FIG. 21 is a flowchart showing operation processing of the workflow system when diverting a flow;

FIG. 22A and FIG. 22B is the first diagram describing an example of screen handling processing when diverting a flow;

FIG. 23A, FIG. 23B and FIG. 23C are the second diagram describing an example of screen handling processing when diverting a flow;

FIG. 24 is a diagram of computer environment; and

FIG. 25 is a diagram showing examples of media.

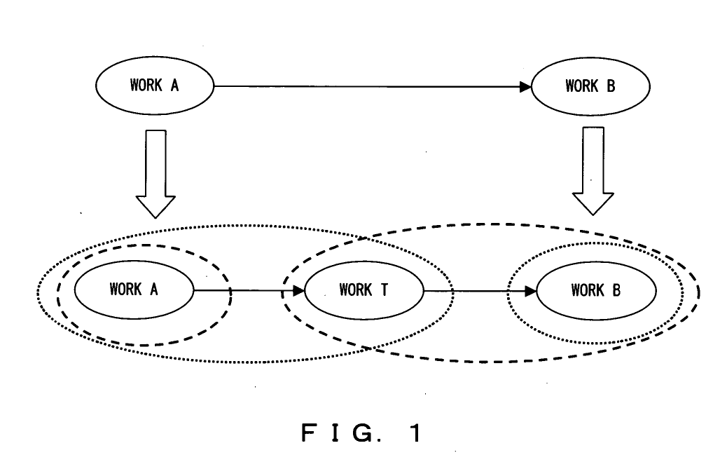

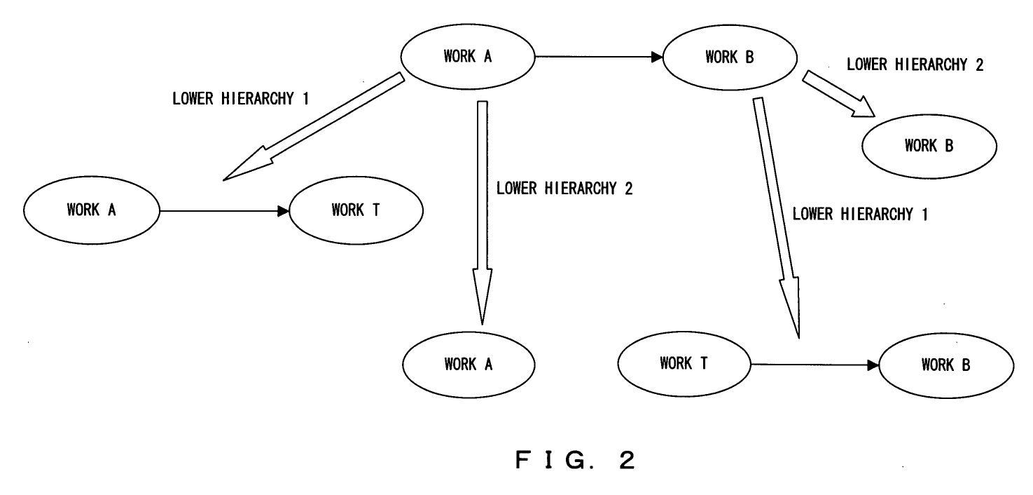

### DESCRIPTION OF THE PREFERRED EMBODIMENT

In the following description, one of the embodiments relating to the present invention is set forth with reference to the drawings. The embodiment described below is an example that the present invention is realized, and therefore the present invention is not limited to the embodiment.

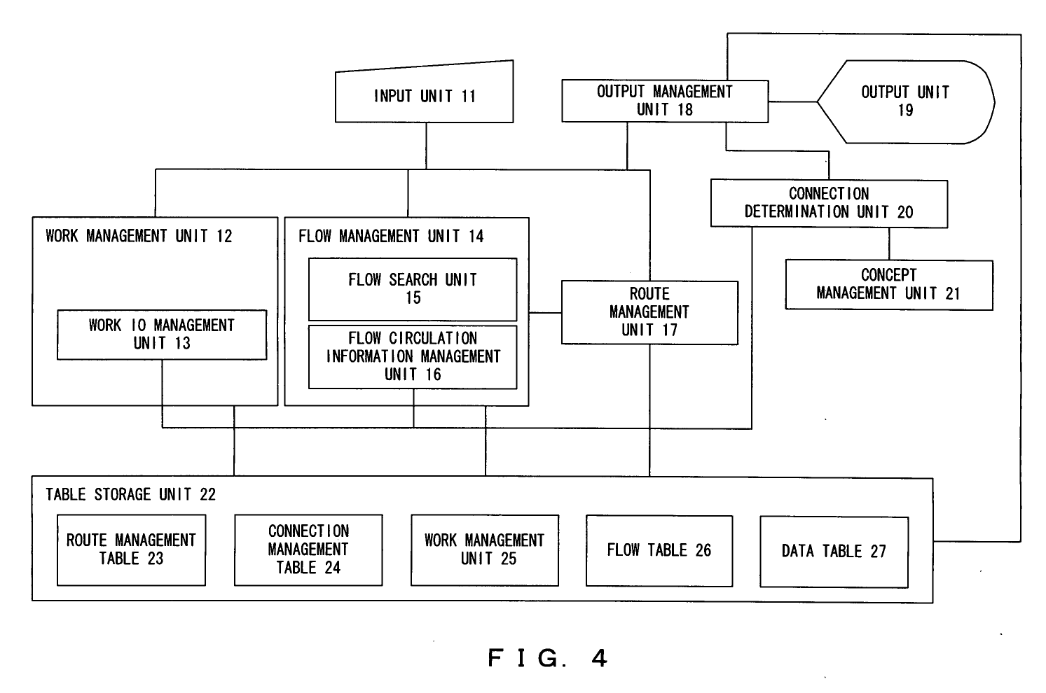

FIG. 4 is a block diagram showing an overview configuration of a workflow system in the present embodiment.

In FIG. 4, the workflow system comprises an input unit 11, a work management unit 12, a flow management unit 14, a route management unit 17, an output management unit 18, an output unit connection management unit 20, a concept management unit 21 and a table storage unit 22.

The input unit 11 is a pointing device such as a mouse or input apparatus such as a keyboard, and the workflow system realizes a man-machine interface to the input operation by a user from the input unit 11. The work management unit 12 controls a work constituting the workflow based on management information recorded in a work management table 25. The work management unit 12, also, comprises a work IO management unit 13 for controlling the types of input/output information to each work. The flow management unit 14 controls a flow constituting the workflow based on the management information recorded in a flow table 26. The flow management unit 14, also, comprises a flow search unit 15 for searching for a flow from conditions input by a user and a flow circulation information management unit 16 for controlling the types of information on the flow, when a flow made into a library is diverted in generating the workflow. The route management unit 17 manages a route indicating a part of the workflow in greater detail based on a route management table 23. In the preset embodiment, the route is managed in a way that it is contained in the upper flow. The output management unit 18 controls the display mode of a workflow chart by controlling display/hide of a plurality of the routes in the lower hierarchy of the flow. The output unit connection management unit 20 determines, when diverting, whether the flow to be diverted is connectable or not to the diverting destination. The concept management unit 21 manages a concept, which is a language when input/output data of the preceding and the subsequent work of the flow is expressed by an abstract language, and its hierarchy. The table storage unit 22 stores the route management table 23, a connection management table 24, the work management table 25, the flow management table 26 and a data table 27, which are tables recording various management information for controlling the workflow. Details of these tables are provided later.

An overview of the way to control the workflow performed in the workflow system of the present embodiment is explained next.

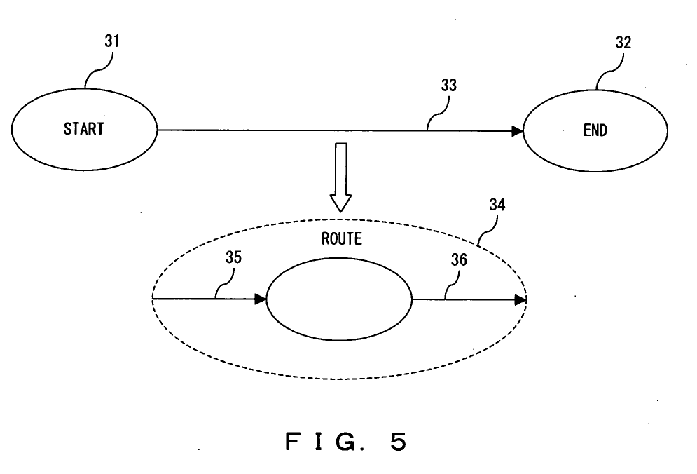

The workflow controlled by the workflow system in the present embodiment is assumed to comprise a start 31, an end 32, and a flow 33 containing a route 34 in the lower hierarchy as shown in FIG. 5 in the most simplified state. The route 34 can be more than one.

The route 34 is a path in the workflow, and comprises workflow items. In the route 34, a first workflow item 35 and a last workflow item 36 have to serve as a flow 35 and a flow 36.

Here, a workflow item is a collective term of basic items (expressed by an arrow or an oval in FIG. 5) constituting a workflow such as a work or a flow. The work is a work unit that an operation is segmented, and is an operation content to be performed by a person in charge of the operation and an item indicating the operation content (indicated by an oval in the present example). The flow is an item connecting the work and visually expressing the flow of the operation (indicated by an arrow in the present example).

The flow 33 in FIG. 5 is an item realizing the present embodiment, and contains the route 34 in its lower hierarchy.

The flow in the present embodiment controls input/output data of the preceding and subsequent work in the flow table 26 as explained later, and therefore it is possible to handle the connectable work independently of a work for determining the input/output data and to divert the work to the other workflow.

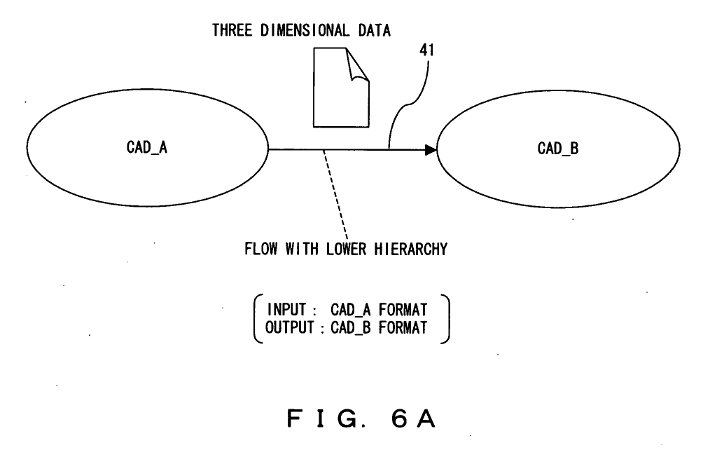

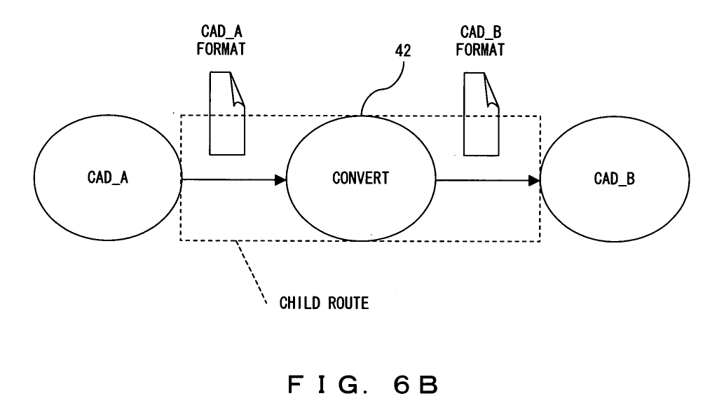

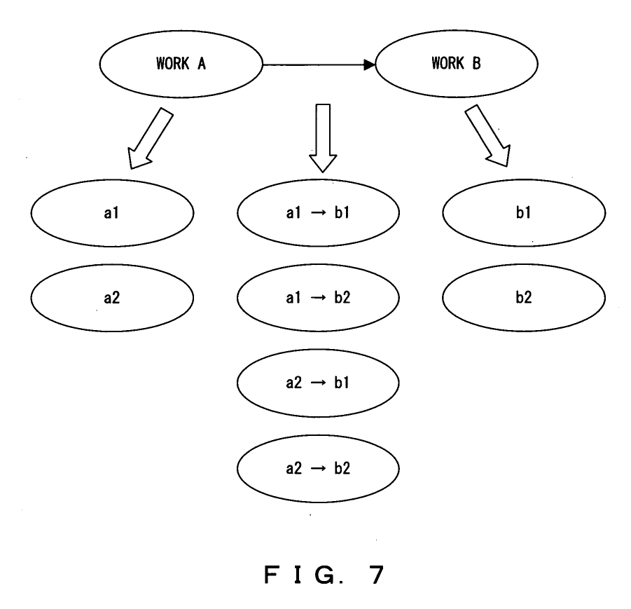

As shown in FIG. 6A and FIG. 6B, for example, when a three dimensional data, which is a work result by a CAD_A, is provided to a CAD_B and the work is performed, in the workflow of the present embodiment, a user defines a data configuration that various three dimensional CAD file formats are present in a flow 41 under a concept of three dimensional data in the flow table 26. The flow 41 contains a route containing a work of conversion in its lower hierarchy.

By so doing, it is possible to switch between a display expressing the delivery of the three dimensional CAD data in the most simplified higher display status as shown in FIG. 6A and a display expressing the convert 42 of the three dimensional data from the CAD_A format to the CAD_B format in the display status one level lower in the display hierarchy as shown in FIG. 6B.

As described above, because a work with an obscure distinction can be defined in the lower hierarchy of a flow, the work convert in FIG. 6, for example, can be defined as a separate work from the work CAD_A and the work CAD_B. Consequently, such work with an obscure distinction can be easily handled. This definition expresses an actual obscure situation that the convert of the work with an obscure distinction can be carried out in either the work CAD_A or the work CAD_B.

In the present embodiment, a flow can maintain a route in its lower hierarchy, and therefore it is possible to create a workflow using a broad (in a higher hierarchy) flow and to add a detailed method as a lower hierarchy of the flow after selecting the detailed method. When the flow maintains a plurality of routes or when the operation is poorly performed by one method, it is possible to present an alternative by selecting another route, resulting in improvement of convenience for the workflow.

In addition, it is possible to organize and accumulate the know-how by continuously adding the detailed content of the operation to the flow as a route in the lower hierarchy of the flow as described above.

FIG. 7 is a diagram explaining the way to manage by the workflow system of the present embodiment in a case that an associated work such as the above work T is present.

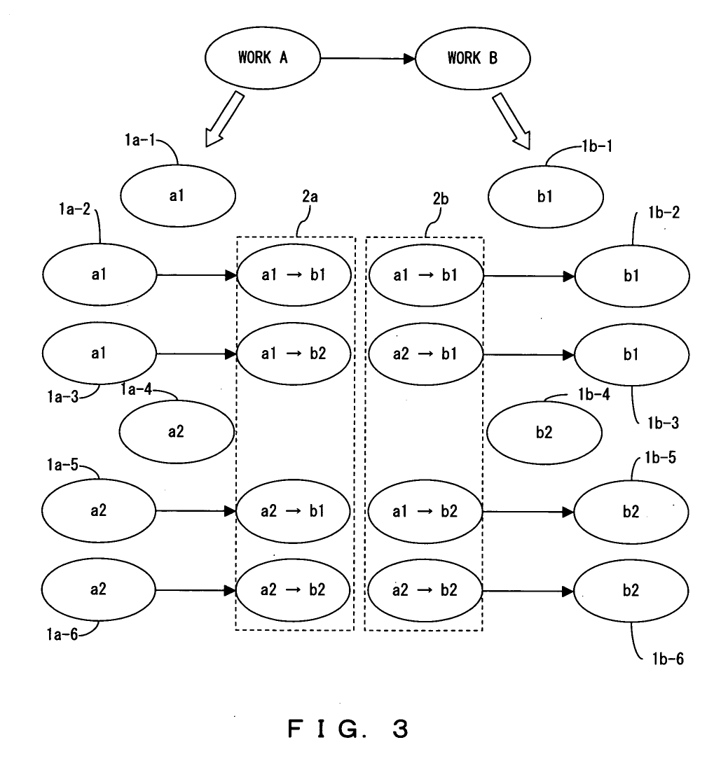

FIG. 7 shows the way to manage by the workflow system of the present invention in a case that each of the work A and the work B has two ways of performance by al and a2, and b1 and b2, respectively, and an associated work is present between each of the performances as shown in FIG. 3.

At that time in FIG. 3, there are 36 combinations; however, the case of the present invention shown in FIG. 7 allows to curb the drastic increase in the number of combinations to 2×4×2=16 combinations at a maximum.

Next, more details of the way to manage a workflow of the workflow system of the present embodiment are set forth.

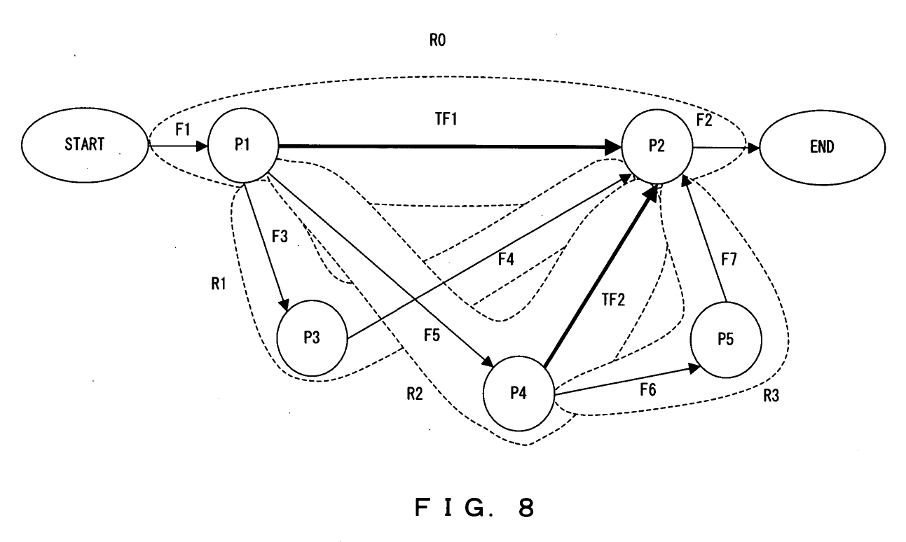

FIG. 8 is a diagram showing a case that all routes present in a workflow shown as an example are displayed.

In FIG. 8, routes R0-R3 are present between a Start and an End, and all routes are displayed.

In such a workflow, when an operation manager sees the overview of the entire workflow, only the route R0, which is in the highest hierarchy, is displayed.

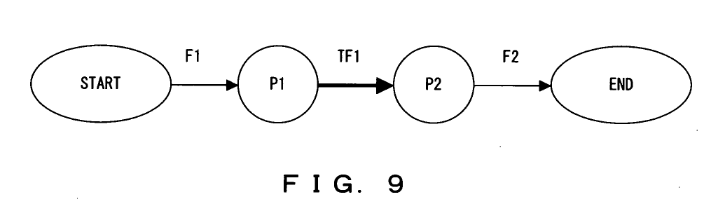

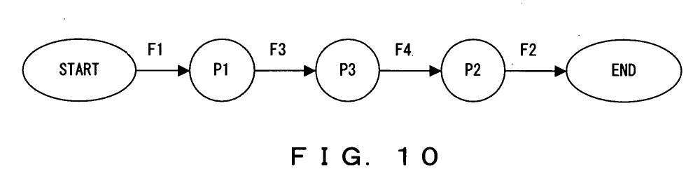

FIG. 9 shows a case that the route R0 alone is displayed.

This case is a case looking at the workflow in the highest hierarchy, and therefore detailed work is omitted, only the minimum required work P1 and P2 and the flows F1 and F2 and TF1 between the work from the Start to the End are displayed.

In the state of FIG. 9, in order to display details of the flow between the work P1 and the work P2, a viewer selects the flow TF1 between the work P1 and the work P2 from the display screen. By so doing, the output management unit 18 switches to the display in a lower hierarchy displaying a route contained by the flow TF1.

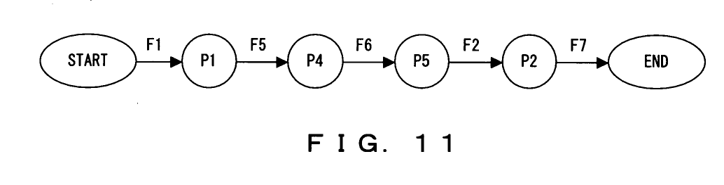

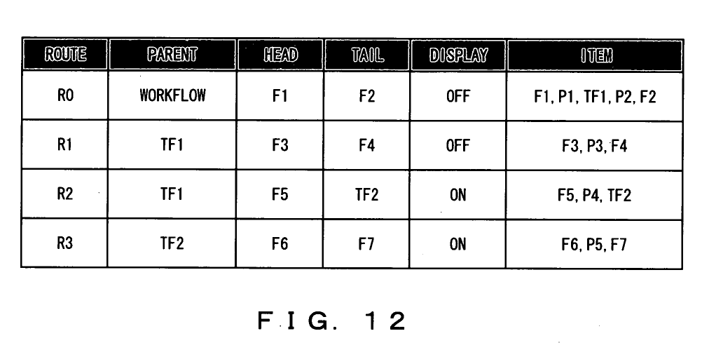

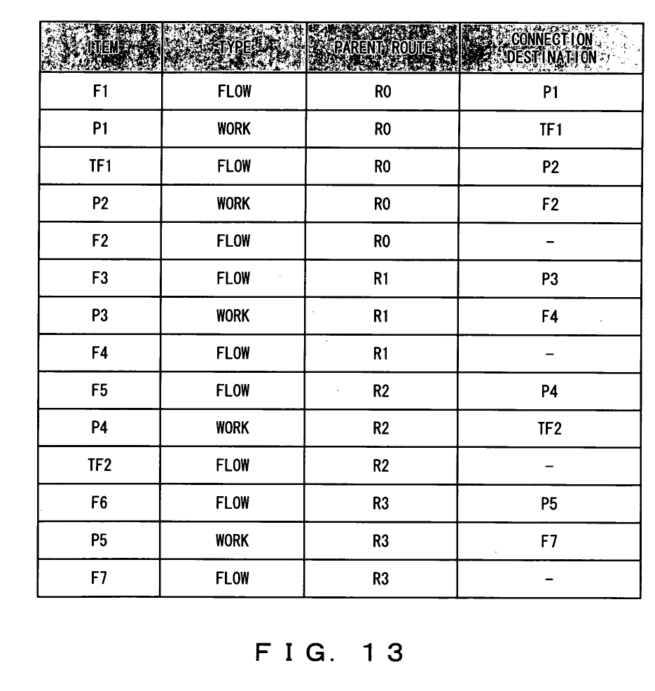

The flow TF1 contains a plurality of routes as shown in FIG. 8. Among them, a display switched to show the route R1 is described in FIG. 10, and a display switched to show the route R2 and the route R3 is described in FIG. 11.

In such a way, the workflow system of the present embodiment can change the details of the display of a part desired by viewers as intended.

Thus, when a viewer requests an overview display in a higher hierarchy, or when a viewer requests a detailed display in a lower hierarchy, the request can be met.

In the following description, what kind of management information manages this workflow is explained.

The workflow is recorded and managed by management information recorded by each table stored in the table storage unit 22.

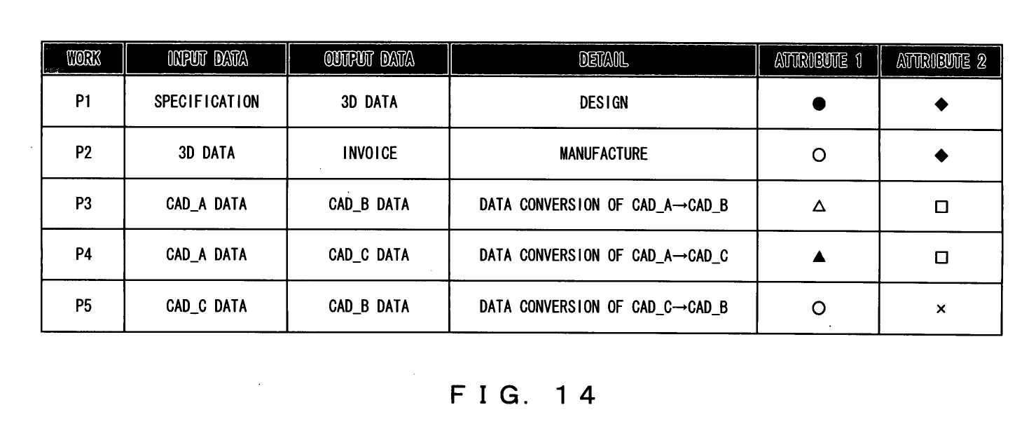

FIG. 12 is a diagram showing an example of a configuration of the route management table 23. FIG. 12 shows the case that the workflow in FIG. 8 is managed as an example.

The route management table 23 manages routes constituting the workflow, and in FIG. 12, management information of the routes R0-R3 in FIG. 8 are recorded.

In the management information, a flow, which is a parent of the route, a flow, which is a head of the route, a flow, which is a tail of the route, a display flag for designating whether the flow is displayed or not by the output unit 19 and items constituting the route are recorded. The route management table 23 in FIG. 12, for example, stores information that the route R1 has a configuration in which the flow TF1 is a parent route containing the route R1 and a configuration, comprising items F3, P3, F4, with the flow F3 as its head, and the flow F4 as its tail, and that the route R1 is currently in a state of hide. The display flag of the route management table 23 is managed by the output management unit 18, and the detail of the displayed workflow is switched by the output management unit 18 switching ON/OFF of the display flag.

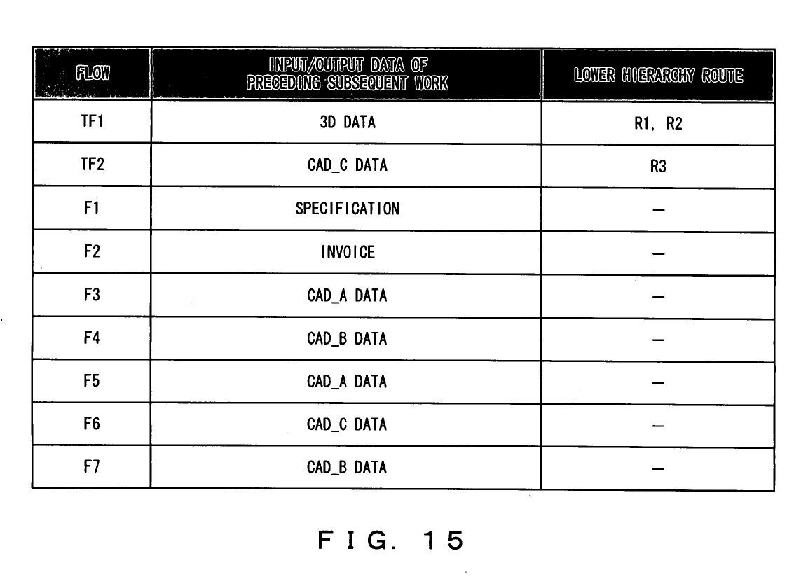

FIG. 13 is a diagram showing an example of a configuration of the connection management table 24. FIG. 13, also, shows the case that the workflow shown in FIG. 8 is controlled as an example.

The connection management table 24 is a table controlling connection of each item constituting the workflow, and types of each item (flow/work), a parent route to which the item belongs and the connection destination of the item are recorded as the management information. In the management table in FIG. 13, for example, it is recorded that an item F1 has a parent route of R0 and a connection destination of the flow of P1.

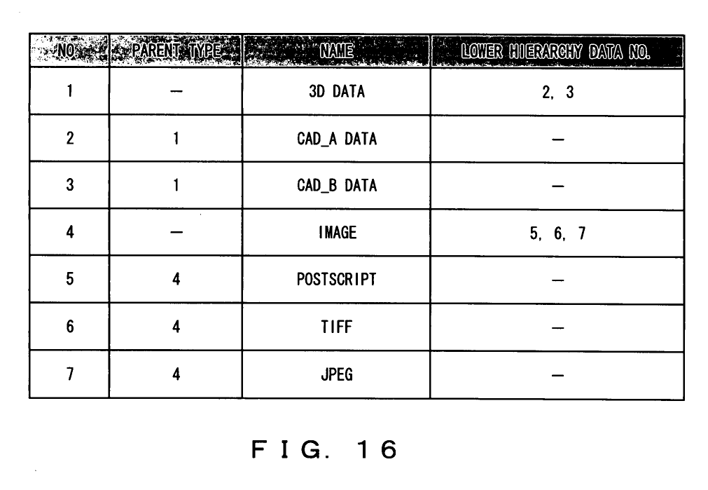

FIG. 14 is a diagram showing an example of a configuration of the work management table 25. FIG. 14, also, shows the case that the workflow shown in FIG. 8 is managed as an example.

The work management table 25 is a table for recording management information for the work among the items in the workflow.

In the management information, input data to be input to the work, output data to be output from the work, a detail name indicating a concept of the work, an attribute 1 and an attribute 2, designating the color and the shape of the work items and used when the work management unit 12 displays the work on the output unit 19, are recorded, and for example, in the work management table 25 in FIG. 14, as the management information for the work P1, specifications as input data, 3D data as output data, a design as a detail name, • as an attribute 1 and ♦ as an attribute 2 are recorded. The detail name is used as a search tag when diverted to the other, or is used for determination of the connection that the connection determination unit 20 performs when connecting flows. The input data and the output data are managed by the work IO management unit 13, and are used for the check in connecting flows.

By the management information recorded and controlled by the route management information 23, the connection management table 24, and the work management table 25, the work management unit 12, the flow management unit 14 and the output management unit 18 display the workflow diagram on the output unit 19.

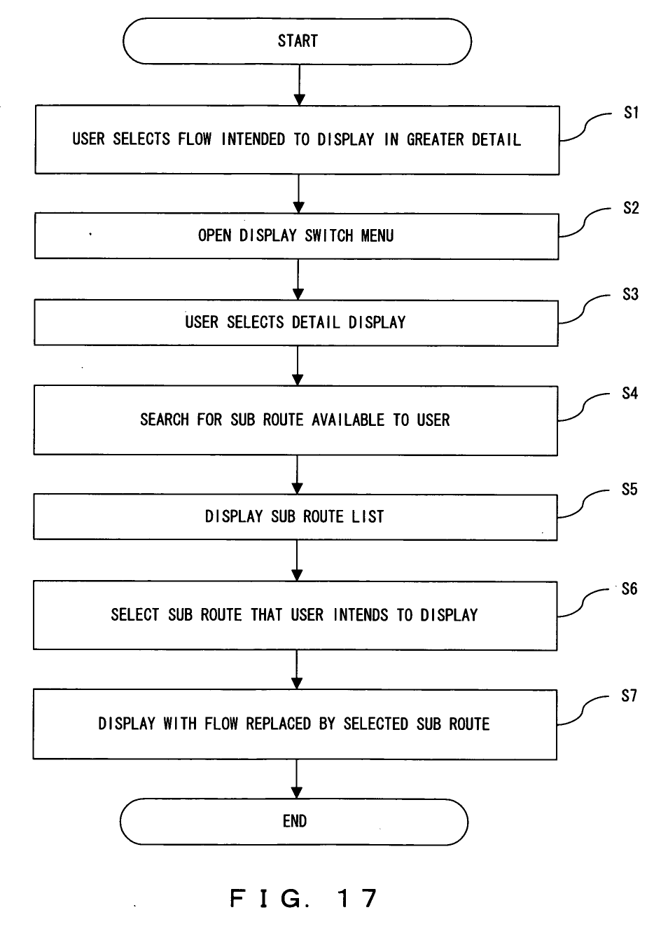

FIG. 15 is a diagram showing an example of a configuration of the flow table 26, and FIG. 15 also shows the case that the workflow shown in FIG. 8 is controlled as an example.

The flow table 26 is a table recording the management information for flows among items in the workflow, and in the case of FIG. 15, the management information of the flows TF1 and TF2 and F1-F7 in FIG. 8 is recorded.

In the management information, input/output data of the preceding and the subsequent work indicating the concept of the data input to/output from the work to be connected and the lower hierarchy route are recorded, and in the case of FIG. 15, for example, 3D data as the input/output data of the preceding and the subsequent work of the flow TF1 and the routes R1 and R2 as the lower hierarchy route are recorded. The input/output data of the preceding and the subsequent work is used as a search tag when diverted to the other, or is used for determination of the connection that the connection determination unit 20 performs when connecting flows. The flow table 26 is used when the flow circulation information management unit 16 of the flow management unit 14 controls the data on the flow.

The flow route 23 is used when changing the detail of the workflow displayed by a user instruction, or when diverting the flow to the other workflow creation.

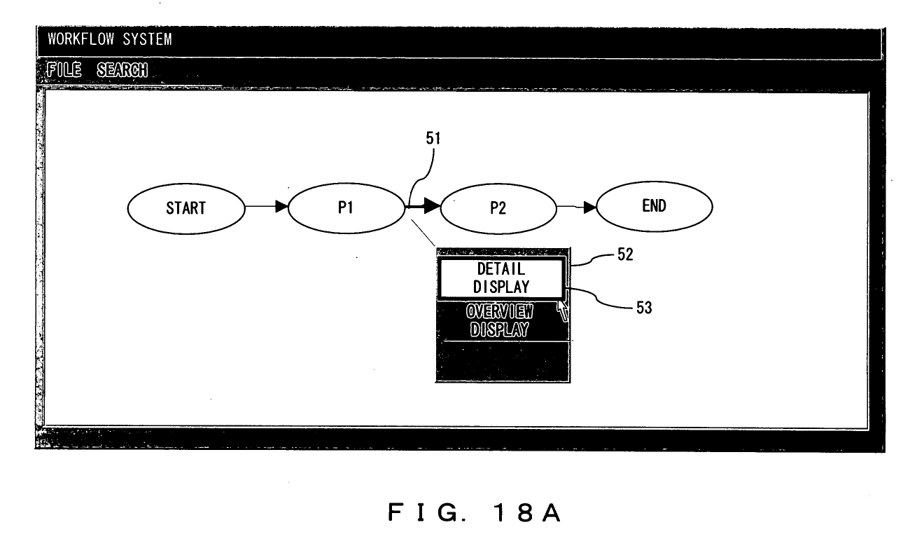

FIG. 16 is a diagram showing an example of a configuration of the data table 27, and FIG. 16 also shows the case that the workflow shown in FIG. 8 is controlled as an example.

The data table 27 controls a concept of the data handled in the workflow in a hierarchy, and stores the name indicating the concept of the data and data of a parent or a lower hierarchy of the data as the management information. In the case of FIG. 16, for example, the flow TF1 is recorded to contain “3D data” as the name, no parent, and data No. 2 and 3 (the names are “CAD_A data” and “CAD_B data”) as the lower hierarchy.

The data table 27 is used when the flow is diverted for the creation of the other workflow.

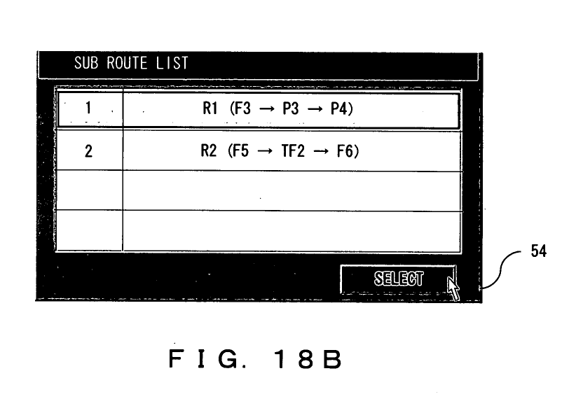

FIG. 17 is a flowchart showing the operation processing of the workflow system when a viewer switches displays from a displayed workflow diagram to more detailed workflow diagram in the lower hierarchy. The processing in FIG. 17 is realized by a CPU in the workflow system, having a main memory device as work memory and executing a program.

In the following description, the operation when a viewer switches the workflow to the lower hierarchy display status is explained with a specific example with reference to the flowchart in FIG. 17.

In a state that the higher hierarchy workflow diagram is displayed on the output unit 19, as step S1, a user, who is a viewer, selects a flow of a part, which is intended to be displayed in greater detail among the items constituting the workflow, from the display screen of the output unit 19 using the input unit 11 such as a pointing device. Then, as step S2, the output unit 19 displays a display switch menu on the display screen.

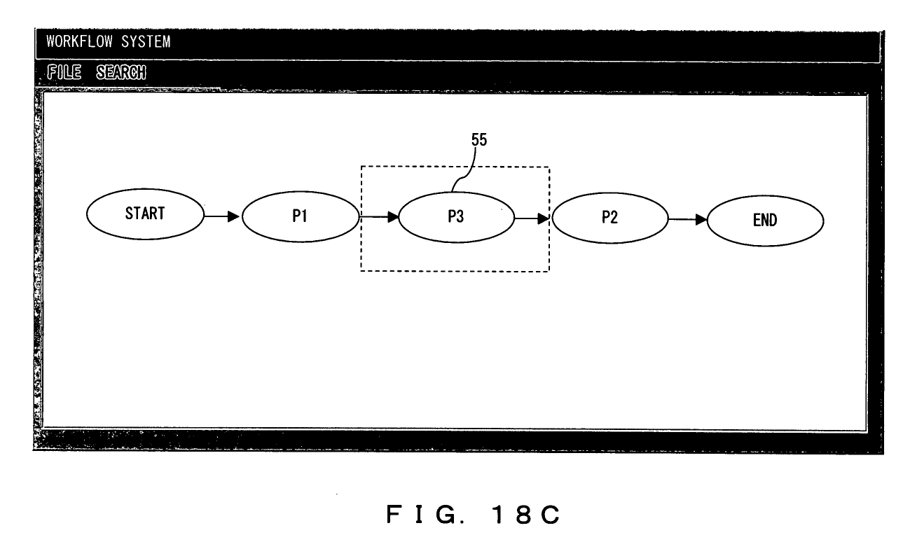

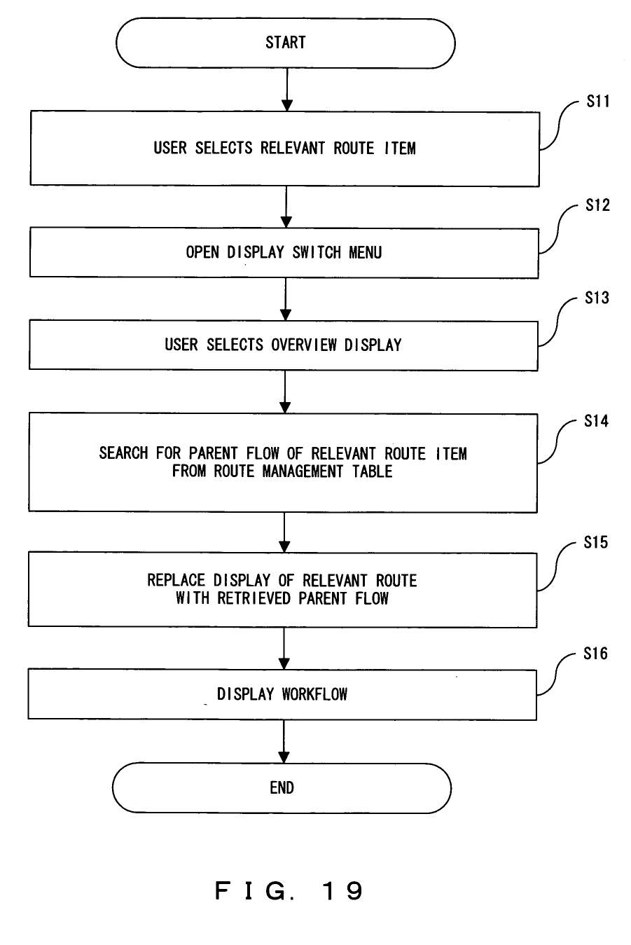

FIG. 18A is a diagram describing the display screen at that time.

In FIG. 18A, when the user selects a flow 51, which is intended to be displayed in greater detail, from the displayed workflow diagram, a display switch menu 52 is displayed on the display screen.

The display switch menu 52 selects a detailed display and overview display and switches them, and when the user selects a detailed display 53 (step S3), a sub-route that is available to the user to see is searched as step S4.

The search for the sub-route is performed by the route management unit 17, the routes in the lower hierarchy of the flow selected by the user in step S1 is acquired by the search in the flow table 26, and they are displayed in a list on the display screen (step S5).

FIG. 18B is a diagram showing an example of displaying the routes listed in step S5.

In such away as the routes available to the user are listed and displayed, the user selects the route to be displayed from the list, and presses the select button 54 on the display screen. By so doing, the route to be displayed is selected (step S6), and as step S7, the flow selected in step S1, replaced by the sub-route selected in step S6, is displayed. The switch of the flow is realized by the output management unit 18 changing the display flag of the route management table 23.

FIG. 18C is a diagram of an example of the display result when the lower hierarchy workflow diagram is displayed replacing the route of which the flow was selected in step S6.

In FIG. 18C, the flow 51 selected in step S1 is replaced by a route 55 (route R1), and a workflow diagram in greater detail in the lower hierarchy than the workflow diagram shown in FIG. 18A is displayed.

As described above, in the workflow system of the present embodiment, the user, who is a viewer of the workflow, is able to select a part to be displayed in greater detail on the display screen as intended, and also able to switch to the detailed display in the lower hierarchy.

FIG. 19 is a flowchart showing processing when a viewer switches a displayed workflow diagram to the overview workflow in the higher hierarchy. The processing in FIG. 19, also, is realized by the CPU in the workflow system having a main memory device as work memory and executing a program.

In the following description, the operation when a viewer switches the workflow to the higher hierarchy display status is explained with a specific example with reference to the flowchart in FIG. 19.

In a state that a workflow diagram is displayed on the output unit 19, as step S11, a user, who is a viewer, selects an item of apart, which is intended to be in an overview display, from the display screen of the output unit 19 using the input unit 11 such as a pointing device. Then, as step S12, the output unit 19 displays a display switch menu on the display screen.

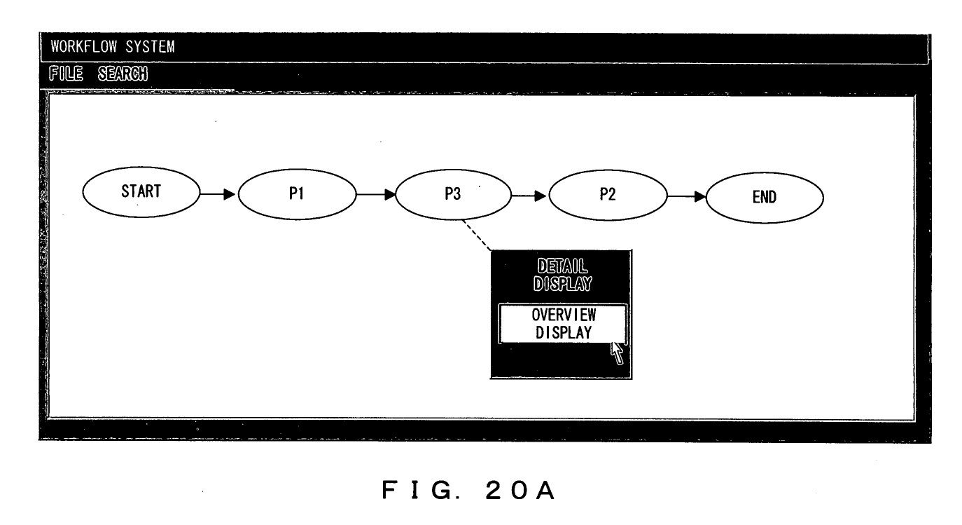

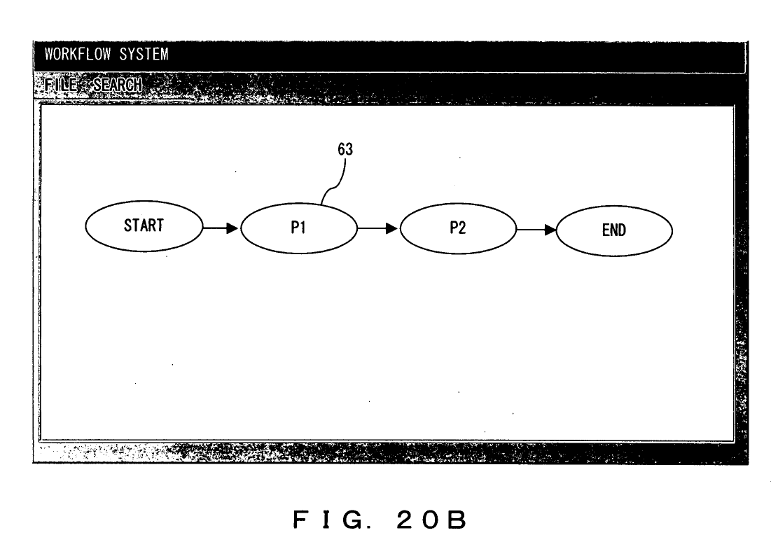

FIG. 20A is a diagram describing the display screen at that time.

In FIG. 20A, when the user selects a work 61 from the display screen, a display switch menu 62 is displayed.

In such a state, when the user selects a overview display of the display switch menu 62 using the input unit 11 (step S13), the route management unit 17 searches for a parent flow of the item selected by the user in step S11 with reference to the items in the route management table 23 as step S14.

As step S15, the route containing the item that the user selected in step S11 is replaced by the parent flow retrieved in step S14, and the workflow diagram is displayed by the output unit 19 also as step S15. The switch of the displays is realized by the output management unit 18 changing the display flag of the route management table 23.

FIG. 20B is a diagram describing a workflow diagram displayed on the display screen at that time.

In the workflow diagram displayed in FIG. 20B, the route containing an item 61 that the user selected in step S11 is replaced by a flow 63, which is a parent flow, and a workflow in the higher hierarchy than that in FIG. 20A is displayed.

In the workflow system in the present embodiment, as described above, it is possible that, in addition to switching a display to a workflow diagram in the lower hierarchy, a user, who is a viewer of the workflow, selects a part to be in an overview display from the display screen as intended, and switches the display to a workflow diagram in the higher hierarchy.

Next, a case of diverting a flow of the existing workflow when creating another workflow.

In the present embodiment, it is possible to divert the flow of the existing workflow when another workflow is newly created.

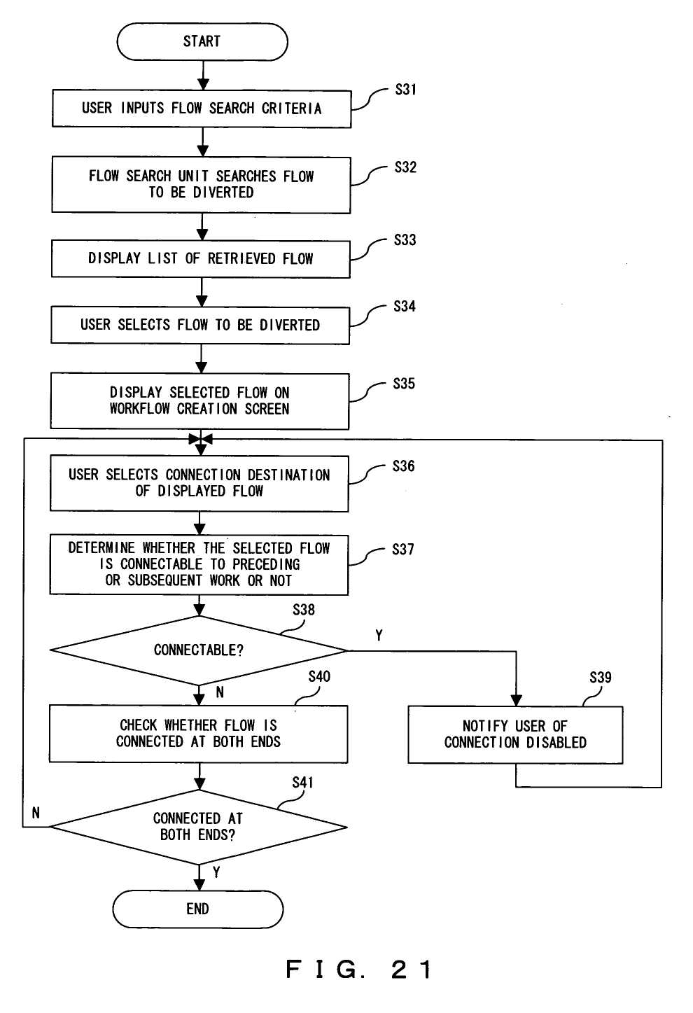

FIG. 21 is a flowchart showing operation processing of the workflow system when diverting the flow. The processing in FIG. 21, also, is realized by the CPU in the workflow system having a main memory device as work memory and executing a program.

In the following description, processing for diverting a flow is explained with reference to the flowchart in FIG. 21.

In a state that a workflow creation screen is displayed, when a user, who is a workflow creator, diverts the existing flow stored in the table recording unit 22 as a library, first, a search menu of the flow is displayed on the display screen, and the search criteria are entered in the flow search menu as step S31.

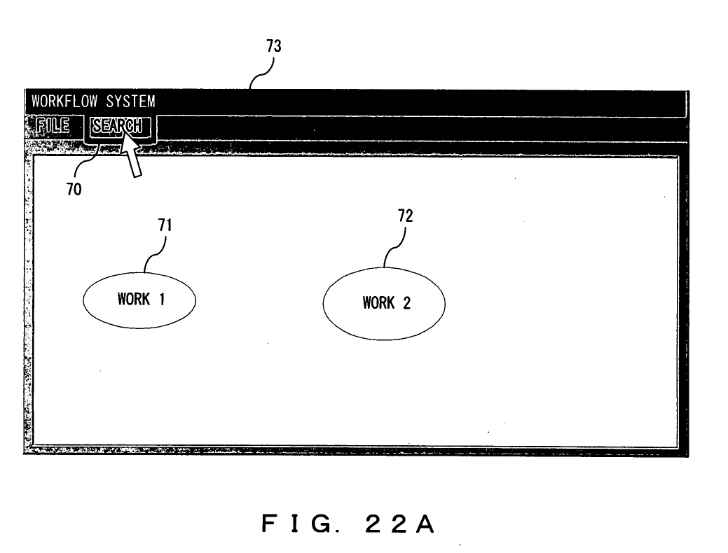

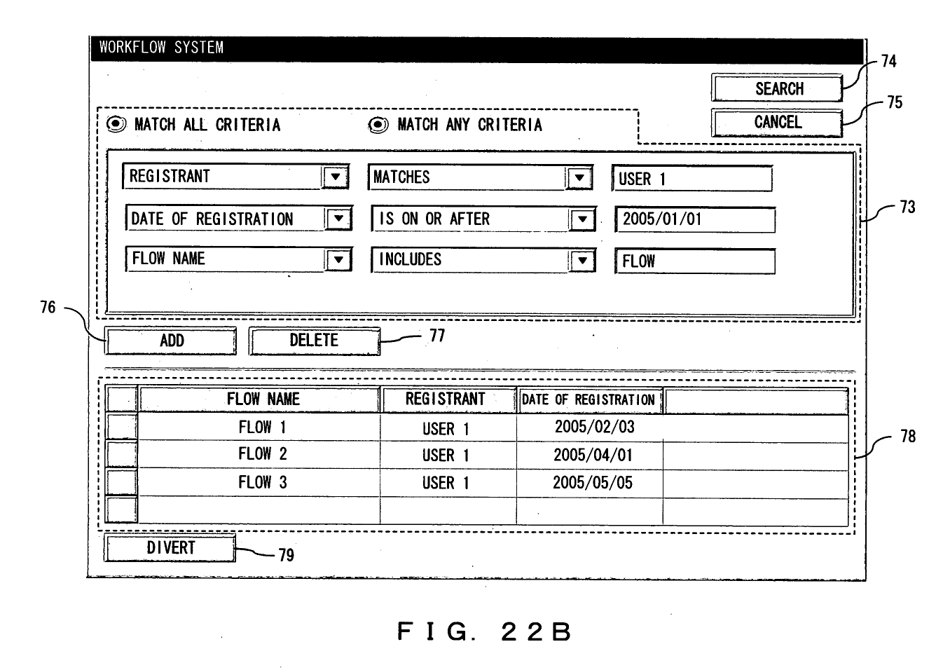

FIG. 22A shows an example of a workflow creation screen, and FIG. 22B shows an example of a search menu.

In the workflow creation screen in FIG. 22A, when the user intends to divert the exiting flow to a flow between work 71 and 72, first, a search command 70 is selected using the input unit 11. By so doing, a search screen shown in FIG. 22B is displayed on the display screen.

On the search screen in FIG. 22B, a search criteria input column 73 is present, and when the user inputs the search criteria in the search criteria input column 73 and presses a search button 74 by the input unit 11 such as a pointing device, as step S32, the flow search unit 15 searches a flow matching the input search criteria from the recorded workflow, and displays the search result on a search result display unit 78 (step S33).

A cancel button 75 is a button to be selected when diverting processing in FIG. 21 is canceled, and when the cancel button 75 is pressed, the search screen is closed, going back to the workflow creation screen in FIG. 22A. An add button 76 and a delete button 77 are used when adding or deleting the search criteria.

When a flow matching the search criteria is retrieved and is displayed on the search result display unit 78, the user, as step S34, selects the flow to be diverted from the flows displayed on the search result display unit 78, and then presses a divert button 79, and selects the flow to be diverted.

By so doing, an item of the selected flow is displayed on the workflow creation screen. If the selected route contains a route in the lower hierarchy, all the routes including the route in the lower hierarchy are to be diverted. This reduces a burden of the workflow creator.

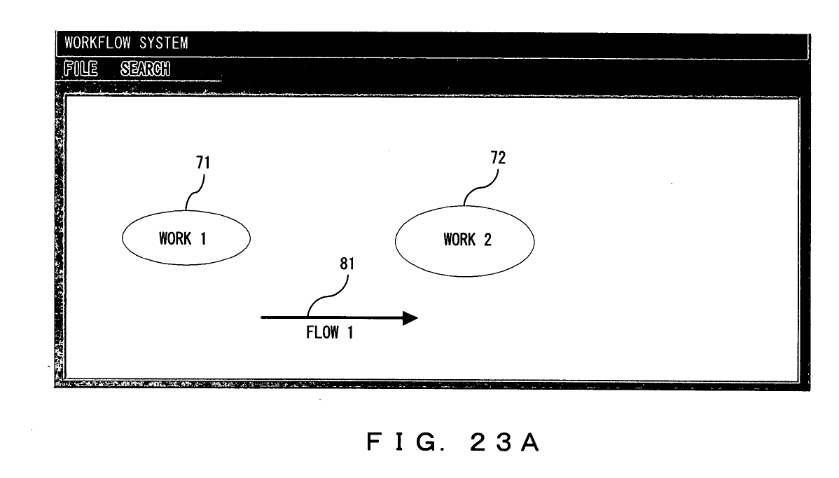

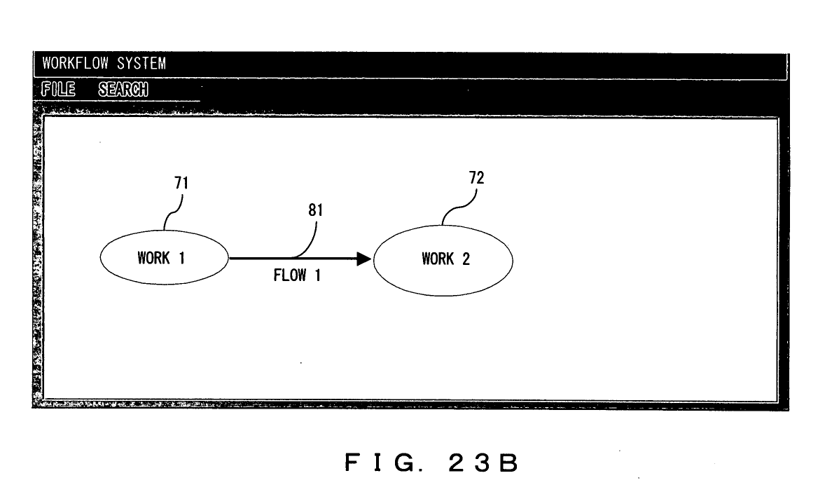

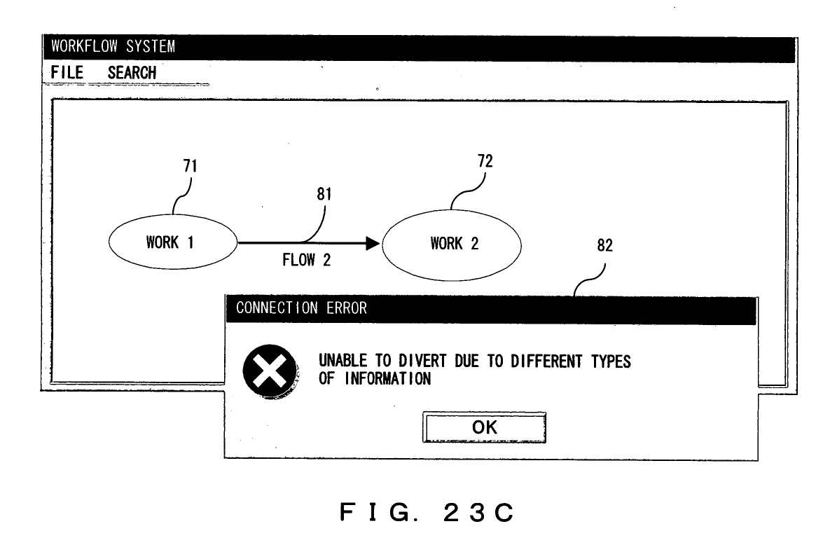

FIG. 23A describes an example of the workflow creation screen in the above state.

In FIG. 23A, an item 81 of the flow that the user selected in step S34 is displayed on the screen.

In such a state, the user, as step S35, selects the connection destination of the item 81 of the flow. The selection is performed by operating the input unit 11 such as a pointing device and moving the item 81 to the connection destination (between the work 71 and the work 72 in FIG. 23A).

When the selection of the connection destination is completed, the workflow system determines whether or not the connection determination unit 20 is connectable to the preceding work (the work 71) or the subsequent work (the work 72) of the connection destination as step S36. As a result, when the determination is connection disabled (step S37, N), the user is notified of the connection disabled from the display of a notice 82 shown in FIG. 23C as step S38, and processing returns to step S35.

When the determination is connectable in step S37 (step S37, Y), as in step S39, whether both sides of the flow are connected or not is determined. In other words, when determining the connection with the preceding work in step S36, the connection with the subsequent work, or when determining the connection with subsequent work in step S36, the connection with the preceding work is determined.

If neither side is connected (step S40, N), the processing goes back to step S35, and if both sides are connected (step S40, Y), the processing is terminated.

The determination of connection in steps S36 and S39 is realized by the connection determination unit 20 checking whether or not the data concepts of the output of the preceding work and the input of the flow match and whether or not data concepts of the input of the subsequent work and the output of the flow match.

As described above, in the workflow system in the present embodiment, it is possible to easily divert the existing flow when creating another workflow. If the flow to be diverted contains a route in the lower hierarchy, the flow including the route can be diverted.

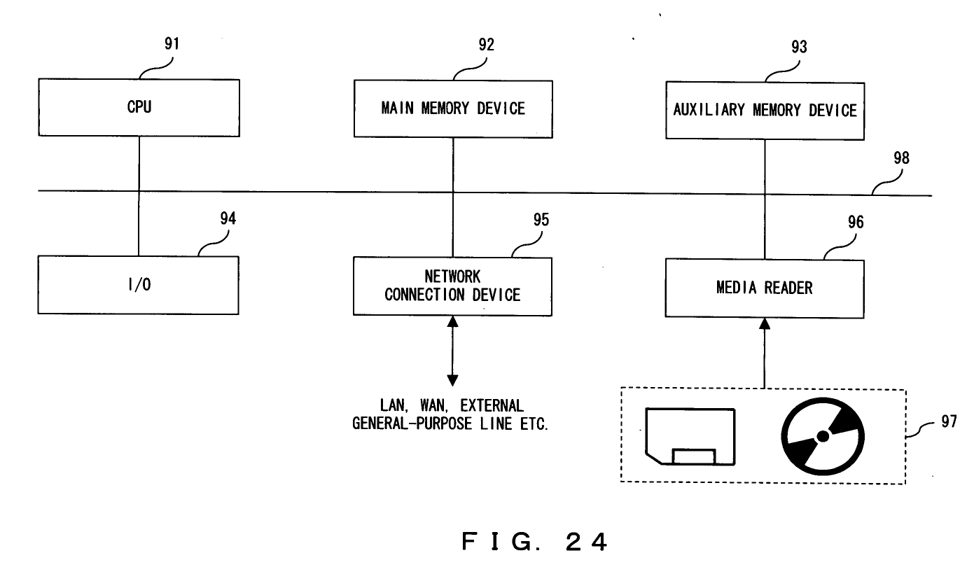

FIG. 24 is a diagram of system environment of a computer when the workflow system in the present embodiment is realized by software.

The computer in FIG. 24 comprises a CPU 91, a main memory device 92, an auxiliary memory device 93 such as a hard disk, an input/output (I/O) device 94 such as a display or a keyboard equivalent to the input unit 11 and the output unit 19, a network connection device 95 such as a modem and a media reader 96 for reading the memory contents from portable storage media such as a disk and an electromagnetic tape, and is configured so that the above devices are connected to each other by a bus 98.

In the computer in FIG. 24, a program and data, stored in memory media 98 such as an electromagnetic tape, a flexible disk, a CD-ROM and an MO, are read by the media reader 96 and are downloaded to the main memory device 92 or the auxiliary memory device 93. By executing or using the program and data by the CPU 91, each function of the work management unit 12, the IO work management unit 13, the flow management unit 14, the flow search unit 15, the flow circulation information management unit 16, the route management unit 17, the output management unit 18, the output unit connection management unit 20 and the concept management unit 21 in FIG. 4 explained above and the processing shown in the flowcharts in FIG. 17, FIG. 19 and FIG. 21 are realized in a form similar to software.

The table storage unit 22 is established in the main memory device 92 or the auxiliary memory device 93.

In the computer system in FIG. 24, there is sometimes a case that application software is exchanged using the storage media 97 such as a flexible disk. Therefore, the present invention is not limited to a workflow system or a workflow management method, but is able to be configured as a computer readable storage media 97, when used by a computer, for causing the computer to perform the above function of the embodiment of the present invention.

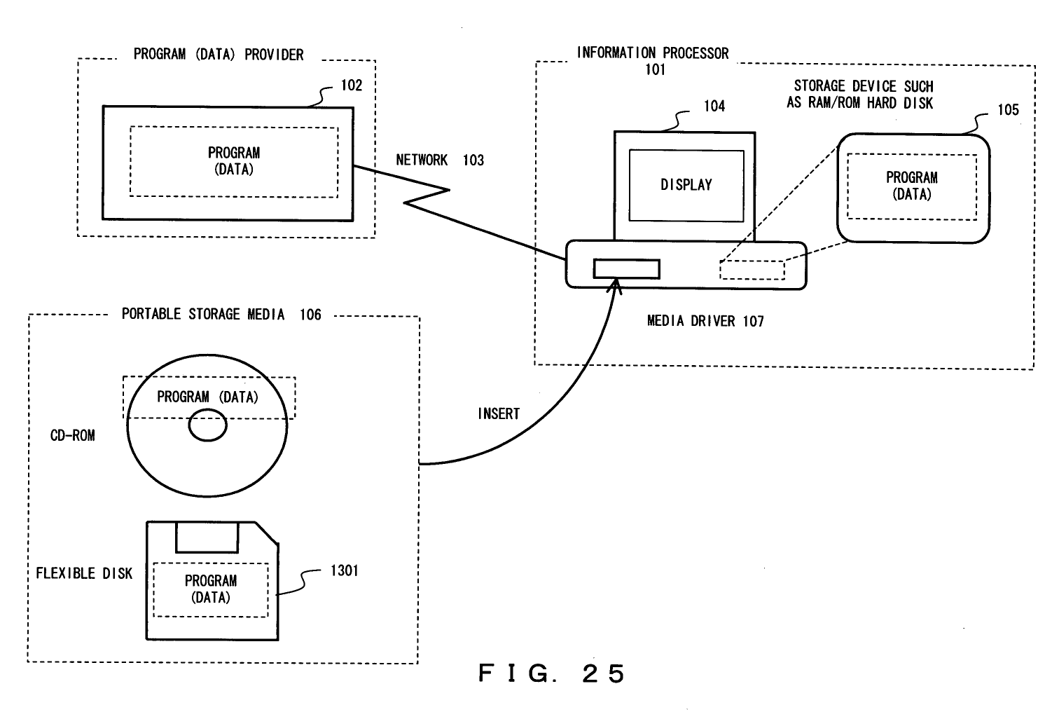

In such a case, the “storage media”, as shown in FIG. 25, for example, includes portable storage media 106 attachable to/detachable from a media driver 107 such as a CD-ROM and a flexible disk (an MO, a DVD, a removable hard disk etc. are also possible), a storage unit 102 (database etc.) in an external device (a server etc.) transmitted via a network line 103, memory 105 (RAM or a hard disk etc.) in a main body 104 of an information processor 101 and so forth. A program, stored in the portable storage media 106 and the storage unit (database etc.) 102, is loaded on the memory (RAM or a hard disk etc.) 105 in the main body 104, and is executed.

In addition to the above examples of the storage media such as a CD-ROM and a DVD-ROM explained above, the present invention can be implemented by using various high-capacity storage media developed from now on such as next generation optical disk storage media using blue laser, that is Blu-ray Disc (trademark) and AOD (Advanced Optical Disc) for example, an HD-DVD9 using red laser, and a Blue Laser DVD using blue-violet laser.

As explained above, the workflow system in the present embodiment allows a user, who is a viewer of the workflow, to freely select a part to be changed in detail of the display on the display screen, and to switch displays of the workflow diagrams to the higher hierarchy or to the lower hierarchy in addition to switch the display to the workflow diagram in the lower hierarchy.

It is also possible to easily divert a flow constituting the existing workflow to another workflow.

What is claimed is:

1. A workflow system for managing a workflow comprising a flow and work comprising:
a work management unit for managing the work;
a route management unit for managing a route representing a part of the workflow; and
a flow management unit for managing the flow to maintain a route in the lower hierarchy of said route.

2. The workflow system according to claim 1, further comprising:
an output unit for display-outputting the workflow; and
an output management unit for causing, when a flow designated by a user maintains the route, the output unit to display-output a workflow in which the flow designated by the user is replaced by the route.

3. The workflow system according to claim 2, further comprising a route selection unit for, when the flow designated by the user maintains a plurality of the routes, displaying the plurality of the routes, wherein the output management unit causes the output unit to display-output the workflow in which the flow designated by the user is replaced by the route selected by the route selection unit.

4. The workflow system according to claim 1, further comprises:
an output unit for display-outputting the workflow; and
an output management unit for causing the output unit to display-output, in the presence of a flow, maintaining a flow or work designated by a user as the route, the workflow, in which the flow or work maintained in the route are replaced by the flow.

5. The workflow system according to claim 1, further comprising:
a flow storage unit for storing a flow constituting the workflow as well as a route that the flow maintains; and
a flow search unit for searching, based on a criteria designated by a user, for a flow, which meets the criteria, from the flow storage unit.

6. The workflow system according to claim 5, further comprising:
a flow selection unit for having a user select one of the flows retrieved by the flow search unit;
a connection position determination unit for determining a connection position of the flow selected by the flow selection unit based on an instruction of the user; and
a connection determination unit for determining whether the flow is connectable or not at the connection position.

7. The workflow system according to claim 6, wherein the connection determination unit determines whether the flow is connectable or not by comparing input/output data of the preceding and the subsequent work of the connection position with data of the flow.

8. The workflow system according to claim 1, further comprising:
a connection management storage unit for storing a connection between the work and the flow, which constitute the workflow, and a route, to which the work and the flow belong;
a route management storage unit for storing a head flow and a tail flow of the route, a flow maintaining the route, and a flow and work constituting the route;
a work management storage unit for storing concepts of input data and output data of a work constituting the workflow;
a flow storage unit for storing a route maintained in the route constituting the workflow and a data concept of the route; and
a data storage unit for storing a concept of the data and data in the lower hierarchy.

9. The workflow system according to claim 8, further comprising:
an output unit for display-outputting the workflow;
an output management unit for examining, when a flow constituting the workflow is designated by a user, whether the flow maintains a route or not with reference to the flow storage unit, and, when a route is maintained, for causing the output unit to display-output the workflow in which the flow is replaced by the route.

10. The workflow system according to claim 8, further comprising:
an output unit for display-outputting the workflow;
an output management unit for finding, when a flow [symbol] or work constituting the workflow is designated by a user, a route to which the flow or work belongs and a flow maintaining the route with reference to the route management storage unit, and for causing the output unit to display-output the workflow in which a flow or work belonging to the route are replaced by the flow.

11. A workflow management method for managing a workflow comprising a flow and work, comprising:
managing the work with reference to a work management storage unit for storing concepts of input data and output data of the work constituting the workflow;
managing a route representing a part of the workflow with reference to a route management storage unit for storing a head flow and a tail flow of the route, a flow maintaining the route, and a flow and work constituting the route; and
managing the flow to maintain a route in the lower hierarchy of said route with reference to a flow storage unit for storing a route, maintained by the route constituting the workflow, and a concept of data of the route.

12. Portable storage medium, for storing a program executed by the computer for managing a workflow comprising a flow and work, which is readable by the computer storing the program causing the computer to execute:
managing the work with reference to a work management storage unit for storing concepts of input data and output data of the work constituting the workflow;
managing a route representing a part of the workflow with reference to a route management storage unit for storing a head flow and a tail flow of the route, a flow maintaining the route, and a flow and work constituting the route; and
managing the flow to maintain a route in the lower hierarchy of said route with reference to a flow storage unit for storing a route, maintained in the route constituting the workflow, and a concept of data of the route.
